(19) United States
(12) Patent Application Publication
(10) Pub. No.: US 2015/0356859 A1
(43) Pub. Date: Dec. 10, 2015

(54) TWO-WAY CALL BACK FOR HOME AUTOMATION SYSTEM

(71) Applicant: Vivint, Inc., Provo, UT (US)

(72) Inventors: Jungtaik Hwang, Draper, UT (US); Michael Tupy, Farmington, MN (US)

(21) Appl. No.: 14/298,323

(22) Filed: Jun. 6, 2014

(51) Int. Cl. G08B 25/01

(52) U.S. Cl. CPC G08B 25/014

(57) ABSTRACT

Methods and systems are described for two-way call back between a control panel of a home automation system and a central station. According to at least one embodiment, an apparatus for two-way call back in a home automation system includes a processor, a memory in electronic communication with the processor, and instructions stored in the memory which are executable by the processor to identify an active alarm condition, initiate a two-way call with a central station, and receive an incoming call from the central station if the two-way call is terminated and the alarm condition is still active.

### BACKGROUND

Advancements in media delivery systems and media-related technologies continue to increase at a rapid pace. Increasing demand for media has influenced the advances made to media-related technologies. Computer systems have increasingly become an integral part of the media-related technologies. Computer systems may be used to carry out several media-related functions. The wide-spread access to media has been accelerated by the increased use of computer networks, including the Internet and cloud networking.

Many homes and businesses use one or more computer networks to generate, deliver, and receive data and information between the various computers connected to computer networks. Users of computer technologies continue to demand increased access to information and an increase in the efficiency of these technologies. Improving the efficiency of computer technologies is desirable to those who use and rely on computers.

With the wide-spread use of computers and mobile devices has come an increased presence of home automation and security products. Advancements in mobile devices allow users to monitor and/or control an aspect of a home or business. As home automation and security products expand to encompass other systems and functionality in the home, challenges exist in communicating between the home automation and security products and a central station, particularly when connections are lost between the central station and the control panel of a home automation and security system.

### SUMMARY

Methods and systems are described for two-way call back between a control panel of a home automation system and a central station. According to at least one embodiment, an apparatus for two-way call back in a home automation system includes a processor, a memory in electronic communication with the processor, and instructions stored in the memory which are executable by the processor to identify an active alarm condition, initiate a two-way call with a central station, and receive an incoming call or a command to reinitiate the two-way call from the central station if the two-way call is terminated and the alarm condition is still active.

In one example, the instructions are executable by the processor to initiate an incoming call mode prior to initiating the two-way call. The instructions may be executable by the processor to terminate the incoming call mode after the alarm condition becomes inactive. The instructions may be executable by the processor to change the alarm condition to an inactive status upon resolution of the alarm condition. The instructions may be executable by the processor to prevent the incoming call from the central station after the alarm condition has the inactive status. The instructions may be executable by the processor to terminate the two-way call if a poor connection is detected. The two-way call may be a cellular phone call. The instructions may be executable by the processor to re-initiate the two-way call with the central station if the two-way call is terminated and the alarm condition is still active.

Another embodiment relates to a computer-implemented method for two-way call back between a control panel of a home automation system and a central station. The method includes initiating a call back mode in response to a detected alarm condition, establishing a two-way call between the control panel and the central station, and receiving a call back call or a command to reinitiate the two-way call from the central station to the control panel to re-establish the two-way call if the two-way call is terminated while the alarm condition is active.

In one example, the method may include terminating the call back mode after the alarm condition is resolved. Establishing the two-way call may include establishing a two-way cellular phone call. The control panel may initiate and terminate the call back mode. The call back mode may be initiated before establishing the two-way call. The method may include detecting the alarm condition with the home automation system.

A further embodiment relates to a computer-implemented method for two-way call back between a control panel of a home automation system and a central station. The method includes participating in a two-way call between the control panel and the central station, wherein the two-way call is initiated in response to an alarm condition. The method also includes identifying a phone number of the control panel, and calling the control panel using the phone number or sending a command to the control panel to re-establish the two-way call if the two-way call is terminated while the alarm condition is active.

In one example, the two-way call may be a cellular phone call, and the method comprises receiving a cellular phone call from the control panel. Identifying the phone number may include searching a database of phone numbers. The database of phone numbers may include phone numbers for a plurality of control panels associated with a plurality of different home automation systems. Identifying the phone number may include using a caller I.D. function. The method may include confirming that the alarm condition is active prior to calling the control panel.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an environment in which the present systems and methods may be implemented;

FIG. 2 is a block diagram of another environment in which the present systems and methods may be implemented;

FIG. 3 is a block diagram of another environment in which the present systems and methods may be implemented;

FIG. 4 is a block diagram of another environment in which the present systems and methods may be implemented;

FIG. 5 is a block diagram of another environment in which the present systems and methods may be implemented;

FIG. 6 is a block diagram of a call module for use in at least one of the environments shown in FIG. 1-5;

FIG. 7 is a block diagram of a call back module for use in at least one of the environments shown in FIG. 1-5;

FIG. 8 is a flow diagram illustrating a method for two-way call back in a home automation system;

FIG. 9 is a flow diagram illustrating a method for two-way call back;

FIG. 10 is a flow diagram illustrating a method for two-way call back between a control panel of a home automation system and a central station;

FIG. 11 is a flow diagram illustrating a method for two-way call back between a control panel of a home automation system and a central station; and

FIG. 12 is a block diagram of a computer system suitable for implementing the present systems and methods of FIGS. 1-11.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The systems and methods described herein relate to home automation and home security, and related security systems and automation for use in commercial and business settings. As used herein, the phrase “home automation system” may refer to a system that includes automation features alone, security features alone, a combination of automation and security features, or a combination of automation, security and other features. While the phrase “home automation system” is used throughout to describe a system or components of a system or environment in which aspects of the present disclosure are described, such an automation system and its related features (whether automation and/or security features) may be generally applicable to other properties such as businesses and commercial properties as well as systems that are used in indoor and outdoor settings.

Most home automation systems communicate directly with a central station via a control panel of the home automation system. Historically, a telephone land line provides the means of communication between the home automation system and a central station. In recent years, other types of communication systems have been implemented including, for example, a network such as the Internet.

In the event of an alarm condition at a property being monitored by the home automation system, the control panel communicates information to the central server. The information may include, for example, details related to the alarm condition. Typically, a one-way communication link is established between the control panel and the central station to convey information to the central station. In response, the central station may dispatch emergency personnel, dispatch maintenance personnel, or contact a user and/or owner of the property being monitored by the home automation system using a separate communication system. The central station may maintain a database of phone numbers for the contacts associated with the home automation system. In addition to telephone numbers, a central station may also maintain a database of other contact information such as, for example, email addresses, pager numbers, Facebook® page addresses, etc.

The one-way communication link between the home automation system (e.g., via the control panel) and the central station may be made available because such communications are typically classified as emergency communications. Emergency communications may be subject to certain government regulations and may be performed at a lower cost or tax free as compared to other types of communications used in commerce. Such emergency communications are typically limited to periods of time associated with an alarm condition for the home automation system.

One aspect of the present disclosure is directed to providing two-way communication between the home automation system and the central station. In one example, the two-way communication is initiated by a control panel of the home automation system in the form of a two-way telephone call. The two-way communication is initiated after determining that an alarm condition exists, receiving information about an alarm condition, and/or receiving a command from the central station. Once the two-way communication is established, the central station may be able to receive communications from the home automation system (e.g., via the control panel), as well as provide communication back to the home automation system. In at least some examples, computing devices of the home automation system may communicate directly with computer devices of the central station to convey information automatically. In other examples, a user of the home automation system may communicate with an operator at the central station using, for example, microphones and speakers. The operator at the central station may provide instructions back to the user of the home automation system concerning, for example, how to address the alarm condition and/or how to operate some aspect of the home automation system. The user may respond to the operator in real-time via the two-way communication.

The two-way communication between the home automation system and the central station may be a two-way cellular telephone call. Cellular communications are notoriously inconsistent and unreliable. Two-way cellular communications are subject to inadvertent disconnection for a variety of reasons including, for example, adverse weather conditions, faulty transmission equipment, poor reception due to distance from a cellular tower, and the like. In the event that the cellular two-way communication link is terminated between the home automation system and the central station, the present disclosure provides for call back capability in which the home automation system reinitiates the two-way call (e.g., in response to a command from the central station or automatically if the initial call is dropped) and/or the central station may call the home automation system (e.g., via the control panel) to reinitiate the two-way call. The central station may obtain the phone number of the home automation system (e.g., control panel) in a number of different ways including, for example, searching a database that maps home automation systems, control panels, and/or properties with the associated phone numbers for communicating with the home automation system. In another example, the central station uses a caller I.D. function to obtain the needed telephone number to conduct the call back call.

In other examples, the control panel of the home automation system may automatically reinitiate the two-way call if the previous two-way call has terminated for any reason. In at least some examples, both the control panel of the home automation system and the central station include modules or other capabilities to monitor the quality of connection of the two-way call, including if the two-way call has terminated. In one example, the central station automatically determines the call back number and reinitiates the two-way call. In other examples, the reinitiation of the two-way call by the central station is conducted manually by, for example, an operator. Typically, the control panel and/or the central station continue to maintain and/or reinitiate the two-way call to the extent needed until such time as the alarm condition is resolved. Once the alarm condition is resolved, the automated and/or manual initiation of two-way calls typically ceases.

The central station may reach out to the home automation system by either calling or sending a command to the home automation system (e.g., control panel) to reinitiate the call based in part on the status of an alarm condition. In many cases, an alarm condition/event at a property being monitored by the home automation system triggers an audible alarm as well as trigger transmission of an alarm message to the control panel and/or central station. The alarm condition may remain active at the control panel and/or central station even after the audible alarm is shut off (e.g., shut off manually by the property owner at the control panel). The alarm condition may remain “active” until an investigation of the events surrounding the alarm condition is conducted and/or someone at the central station, or the software of the central station, ends the investigation or otherwise terminates the alarm condition. Thus, an “active alarm” is not necessarily terminated when the audible alarm is shut off automatically or manually at the control panel, but rather is terminated only after additional steps have been taken within a predetermined time period of the alarm event first occurring. In at least some examples, determining whether a call back call should be made is based on actions taken at the central station rather than at the home automation system (i.e., on location at the monitored property).

The home automation system may have a standby mode and a call back mode. In the standby mode, the home automation system awaits an alarm condition. Once the alarm condition is determined and/or verified, the home automation system may initiate a call back mode. The call back mode may place the home automation system in a state in which it will search for and/or receive incoming calls from the central station. When a home automation system is in the standby mode, the call back calls from central station may be ignored and/or not result in initiation of the desired two-way call between the home automation system and the central station. The home automation system may change from the call back mode back to the standby mode automatically upon resolution of the alarm condition. In other examples, the switch between the call back mode and the standby mode is performed manually or, at least in part manually, by requiring user input (e.g., confirmation that the alarm condition is resolved).

The term “two-way communication” may refer to communications in which two parties can each send and receive information such as communication in which each party listens to an audio message (e.g., via a speaker) and generates a responsive audio message (e.g., via a microphone). The term “real-time” may include relatively instantaneous communications, with expected brief delays associated with transmission of the electronic signal over any of a variety of communication mediums (e.g., wired or wireless). For example, a telephone conversation conducted over a wired or wireless system typically provides real-time audio communication, although brief delays may occur depending upon, for example, the distance between persons participating in the call and the technology used (e.g., satellite, wireless, fiber optic, etc.).

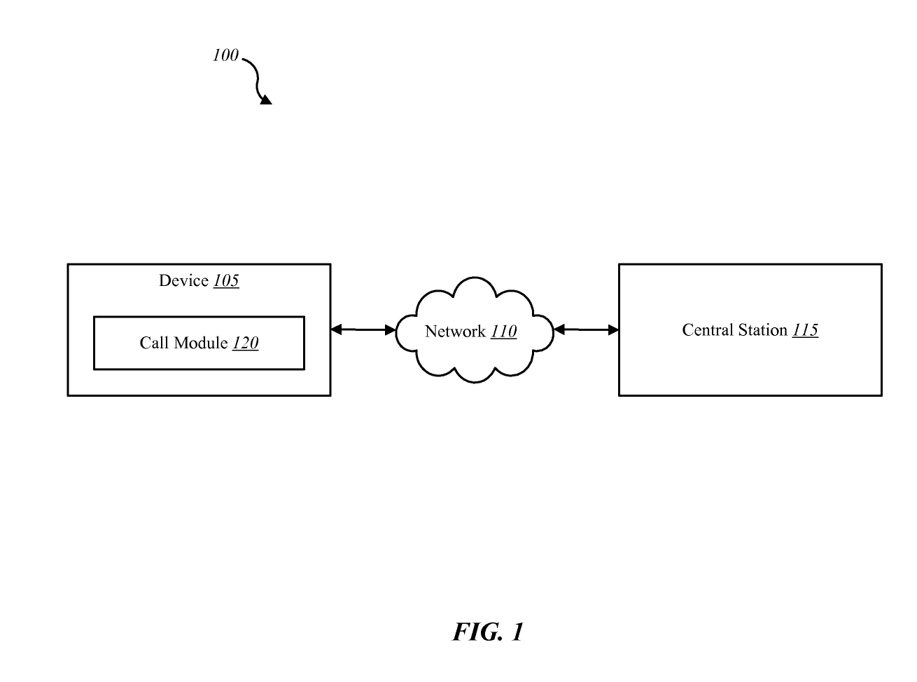

FIG. 1 is a block diagram of one embodiment of an environment 100 in which the present systems and methods may be implemented. In some embodiments, the systems and methods described herein may be performed, at least in part, using a device 105 and a central station 115 that communicate via a network 110. The device 105 may include a call module 120. The call module 120 may operate at least in part to provide two-way communication between device 105 and central station 115. The two-way communication may include a two-way call such as a two-way cellular phone call. Device 105 may be part of, for example, a home automation system.

Generally, environment 100 may include a home automation system and/or environment 100 may be part of a home automation system. As used herein, the term “home automation system” may include one or more devices 105, wherein the device 105 is a control panel. The home automation system may be separate and distinct from central station 115. Additionally, or alternatively, the home automation system may include central station 115 as well as device 105 and other components and/or features as described herein with reference to FIGS. 1-12.

Call module 120 may facilitate two-way communication between device 105 and central station 115. For example, module 120 may provide a two-way telephone call between device 105 and central station 115. The two-way telephone call may be a two-way cellular telephone call. The term “two-way call” as used herein may be defined as a telephone call-in which communications may be sent and received at both device 105 and central station 115. New communications may include voice communications, text communications, and/or video communications. The two-way call may be initiated by call module 120 or other features of device 105. Additionally, or alternatively, central station 115 may initiate the two-way call to device 105. Central station 115 may have at least one unique telephone number assigned thereto for the dedicated purpose of establishing the two-way telephone call.

Network 110 may facilitate the two-way telephone call between device 105 and central station 115. Network 110 may include local area networks (LAN), wide area networks (WAN), virtual private networks (VPN), wireless networks (using 802.11 for example) and/or cellular networks (using 3G and/or LTE, for example), etc. In some embodiments, network 110 may include the Internet.

The two-way telephone call between device 105 and central station 115 may be initiated in response to identification of an alarm condition. The alarm condition may be associated with a property being monitored by a home automation system of which at least device 105 is a part. As noted above, device 105 may be, for example, a control panel of a home automation system. The alarm condition may include any of a number of conditions such as, for example, unauthorized entry into a home, smoke detection, water leak, malfunctioning appliances, fire, carbon monoxide leak, and the like. The alarm condition may be classified as an emergency. An emergency situation may justify generating the two-way telephone call between device 105 and central station 115, whereas other types and/or communication systems may be used in other situations such as, for example, if a user merely has a question to ask of an operator at the central station or some other non-emergency situation.

Once the alarm condition is identified, call module 120 may initiate the two-way call between device 105 and central station 115. If the two-way call is terminated unintentionally (e.g., due to a poor cellular connection), call module 120 may reinitiate the two-way call. Call module 120 may continue to reinitiate the two-way call as many times as necessary due to inadvertent termination of the two-way call until such time as the alarm condition is resolved. In at least some embodiments, central station 115 may be configured with capabilities to make a call back call from central station 115 to device 105 in the event that the two-way call is, for example, inadvertently terminated or terminated intentionally due to poor cellular connection or the like, and the alarm condition is still active. Central station 115 may look up the telephone number for the call back call from a database that maps telephone numbers associated with each device 105 that central station 115 services.

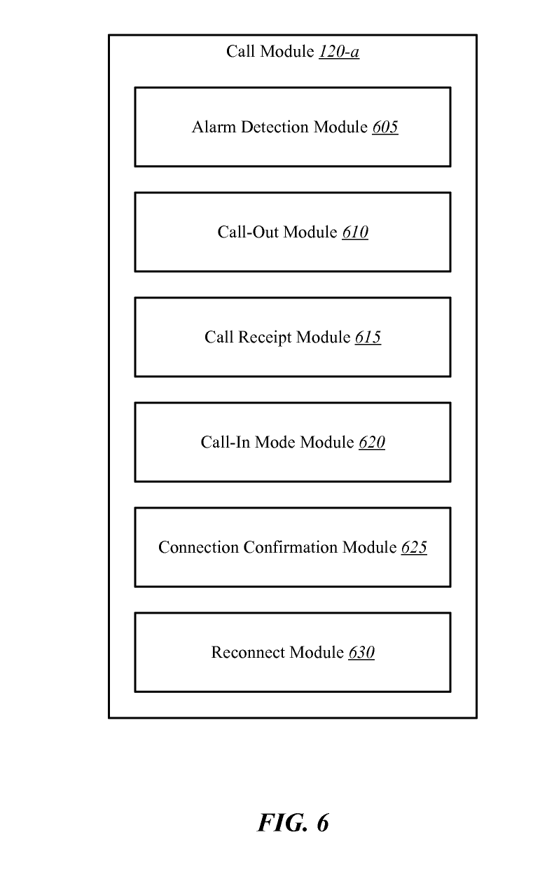

Call module 120 may perform a variety of functions related to, for example, identifying and confirming an alarm condition and the status of the alarm condition, initiating and/or reinitiating a two-way call between device 105 and central station 115, accepting calls from central station 115, confirming the two-way call connection between device 105 and central station 115, and other features as described below with reference to FIG. 6.

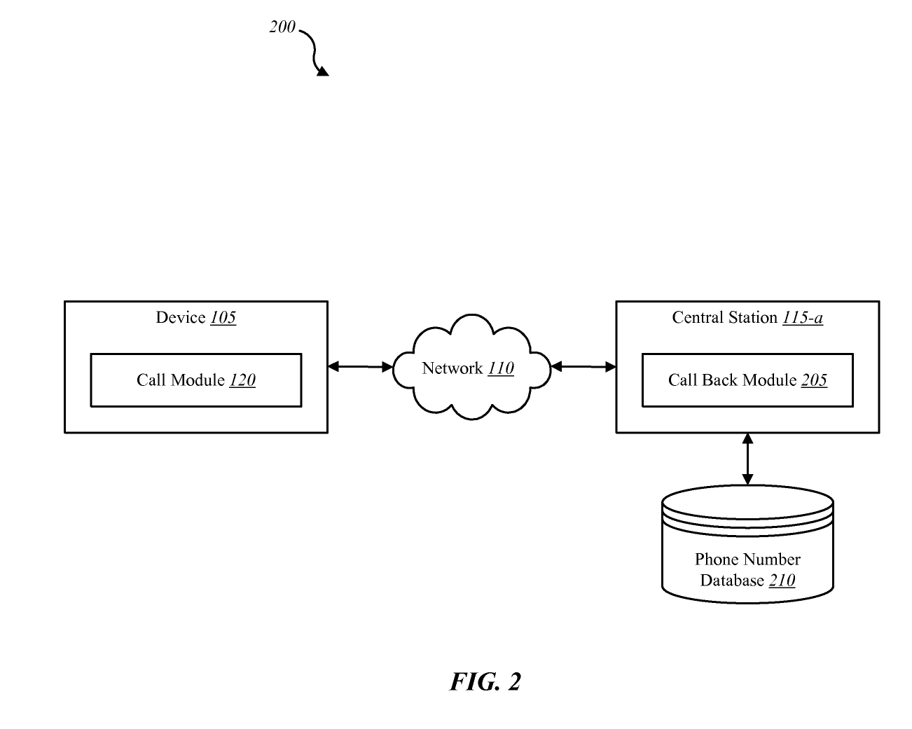

FIG. 2 shows another environment 200 that may include the components of environment 100 described above, and may further include central station 115-a having a call back module 205 and a phone number database 210. Call back module 205 may operate in at least two circumstances. In a first circumstance, call module 120 has previously initiated a two-way call between device 105 and central station 115-a. The two-way call is terminated for some reason (e.g., poor cellular reception). Call back module 205 may identify when the two-way call has been terminated and then facilitate a call back call to device 105 to reinitiate the two-way call. The call back call may be performed manually by, for example, an operator at central station 115-a. Additionally, or alternatively, call back module 205 may automatically reinitiate the two-way call.

The phone number used to initiate the call back call from call back module 205 may be determined using a caller I.D. function that provides the telephone number for device 105 based on the initial two-way call initiated by device 105. Additionally, or alternatively, call back module 205 may conduct a search for the phone number in phone number database 210. Phone number database 210 may include telephone numbers for each device 105 being monitored by central station 115-a. Phone number database 210 may include phone numbers for each device 105 as well as phone numbers for contacts associated with device 105 (e.g., mobile phone numbers and work phone numbers for one or more users of a home automation system that includes device 105). Call back module 205 may use at least one phone number found in a search of phone number database 210 to automatically reinitiate the two-way call via a call back call, or provide the telephone number to the operator to manually place the call back call to reinitiate the two-way call.

In some embodiments, both the call module 120 and call back module 205 may be capable of reinitiating a two-way call after an initial two-way call is terminated (i.e., inadvertently or intentionally). In other examples, only one or the other of call module 120 and call back module 205 may be capable of reinitiating the two-way call after termination of an initial two-way call. As described above, reinitiating a two-way call, whether conducted by call module 120 or call back module 205, may be performed repeatedly as needed after each termination of the two-way call until such time as the alarm condition is resolved.

Resolution of the alarm condition may be performed automatically or manually. For example, a manual resolution of an alarm condition may include confirmation from a user of device 105 and/or the home automation system of which device 105 is a part. The manual confirmation may include, for example, entry of a user code, or response to a question whether the condition exists (e.g., false smoke alarm, etc.). An automatic resolution of the alarm condition may be performed when, for example, sensors or other electronic features used to identify the alarm condition confirm that the alarm condition no longer exists, which information is used by device 105 or other features of the home automation system to update the alarm condition status to inactive. In some examples, central station 115-a includes capability to terminate the alarm condition in view of certain actions that are taken such as, for example, calling emergency or maintenance personnel, receiving confirmation from a user that the alarm condition is resolved at the property being monitored by the home automation system, or the like.

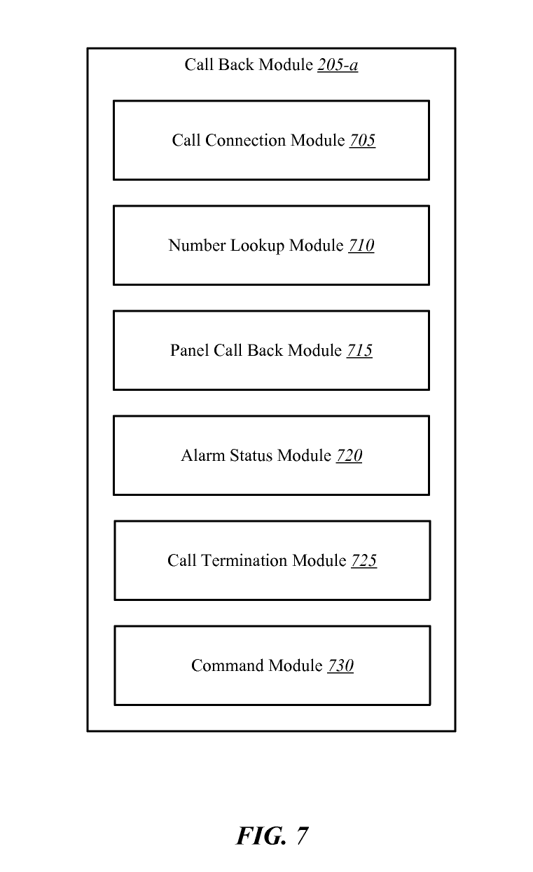

Call back module 205 may provide a number of functions including, for example, confirming connectivity of the two-way call between device 105 and central station 115-a, looking up a telephone number (e.g., via a caller I.D. or the phone number database 210), initiating a two-way call between central station 115 and device 105, confirming a status of the alarm condition, and terminating the two-way call if insufficient connectivity is detected (e.g., poor cellular reception). Additional functions related to call back module 205 are described below with reference to FIG. 7.

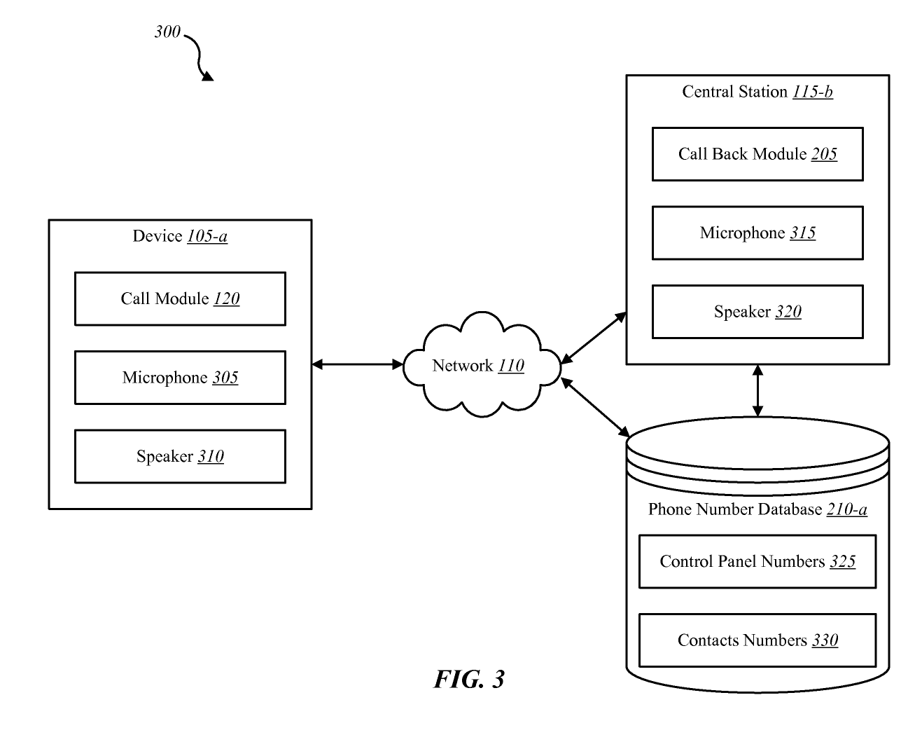

FIG. 3 shows another environment 300 that may include the components of environments 100, 200, described above, and may further include a device 105-a including a microphone 305 and a speaker 310, a central station 115-b including a microphone 315 and a speaker 320, and a phone number database 210-a having control panel numbers 325 and contact numbers 330.

The microphone 305 and speaker 310 of device 105-a may facilitate two-way voice communications by a user of device 105-a. Microphone 315 and speaker 320 may facilitate two-way audio communications by an operator at central station 115-b. Once a two-way call is initiated between device 105-a and central station 115-b, whether initiated by call module 120 or call back module 205, ongoing audio communications may be facilitated using the microphones 305, 315 and speakers 310, 320.

As mentioned above, phone number database 210-a may include a database of telephone numbers for the devices 105 being monitored by central station 115-b. Furthermore, phone number database 210-a may include a plurality of contacts numbers 330 for one or more users of device 105. For example, contacts numbers 330 may include work, personal (e.g., cell phone), next of kin, neighbor, or other phone numbers for one or more users of device 105. The contacts numbers 330 are typically separate from the control panel numbers 325 that are used to provide the two-way calls between device 105 and central station 115-b.

Microphone 305 and speaker 310 are shown as components included in device 105-a. In one example, microphone 305 and speaker 310 may be integrated into a housing of a control panel. In other examples, microphone 305 and speaker 320 may be provided as separate components of a home automation system and may be accessible separately from device 105-a. For example, speaker 310 may be a separate ceiling-mounted speaker of the home automation system and microphone 305 may be a separately mounted microphone which is used to receive spoken inputs from a user at various locations within a property being monitored by the home automation system. Similarly, microphone 315 and speaker 320 may be provided as separate devices and/or components such as, for example, a headset being worn by an operator at central station 115-b.

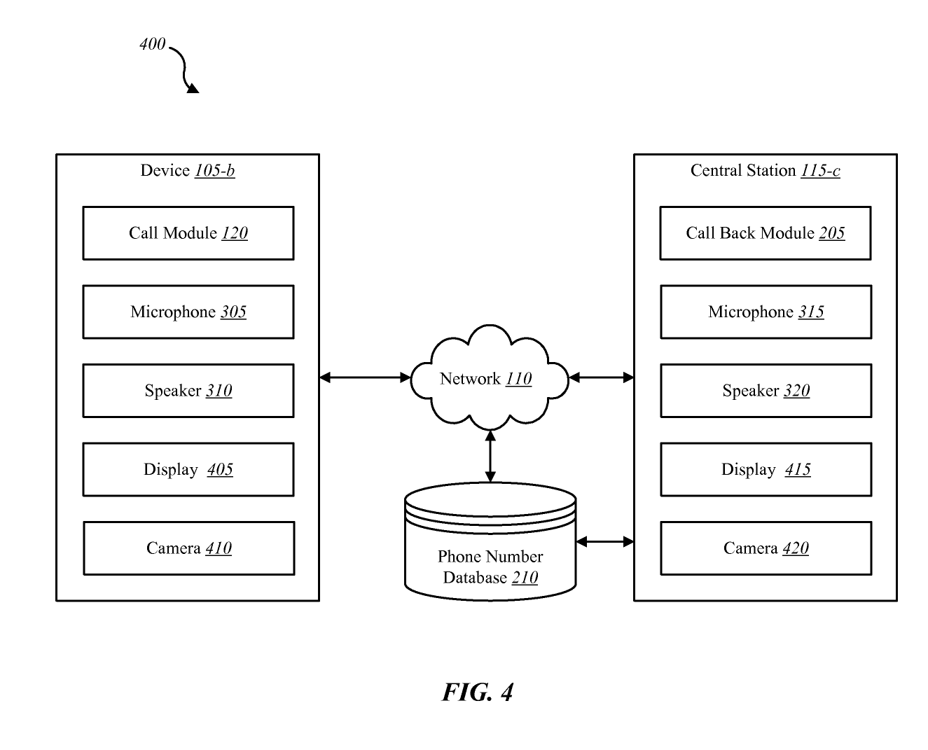

FIG. 4 shows another environment 400 that may include the components of environments 100, 200, 300, described above, and may further include a device 105-b having a display 405 and camera 410, and a central station 115-c having a display 415 and camera 420. The displays 405, 415 and cameras 410, 420 may facilitate video communications between device 105-b and central station 115-c. The video communications may be used alone or in combination with the audio communications facilitated by microphones 305, 315 and speakers 310, 320.

Displays 405, 415 may facilitate other types of communication such as text communication, wherein a plurality of words, symbols, colors, etc., may be displayed on display screen 405 to communicate information between device 105-b and central station 115-c. The communications made via displays 405, 415 may be made automatically by electronic devices of device 105-b and central station 115-c. Additionally, or alternatively, some of the messages conveyed via displays 405, 415 may be manually entered by users and/or operators of device 105-b and central station 115-c. For example, call back module 205 may identify a call back number for device 105 via, for example, a search in phone number database 210, and display the phone number on display 415 so that an operator may manually initiate a call back call to device 105-b. The call back call may be made in response to an alarm condition being conveyed from device 105-b to central station 115-c. Additionally, or alternatively, the call back call may be made in response to unexpected termination of a two-way call that was previously initiated by call module 120 to central station 115-c.

While the microphone 305, speaker 310, display 405 and camera 410 are shown as components of device 105-b, other embodiments may include at least some of those components as being separate from device 105-b. Similarly, microphone 315, speaker 320, display 415 and camera 420 may be provided as separate components, or may be integrated into a common housing with call back module 205 or other features of central station 115-c. In at least some examples, phone number database 210 may be included in central station 115-c rather than being provided as a separate database and/or component accessible by features of central station 115-c.

Phone number database 210 may be in direct communication with, for example, call back module 205. Additionally, or alternatively, phone number database 210 may be accessible via network 110. In at least some examples, phone number database 210 is also accessible by device 105-b (e.g., call module 120). For example, call module 120 may operate to conduct a search in phone number database 210 for one or more contact phone numbers for users of device 105-b or backup phone numbers for central station 115-c in the event that a preprogrammed phone number for central station 115-c is unavailable.

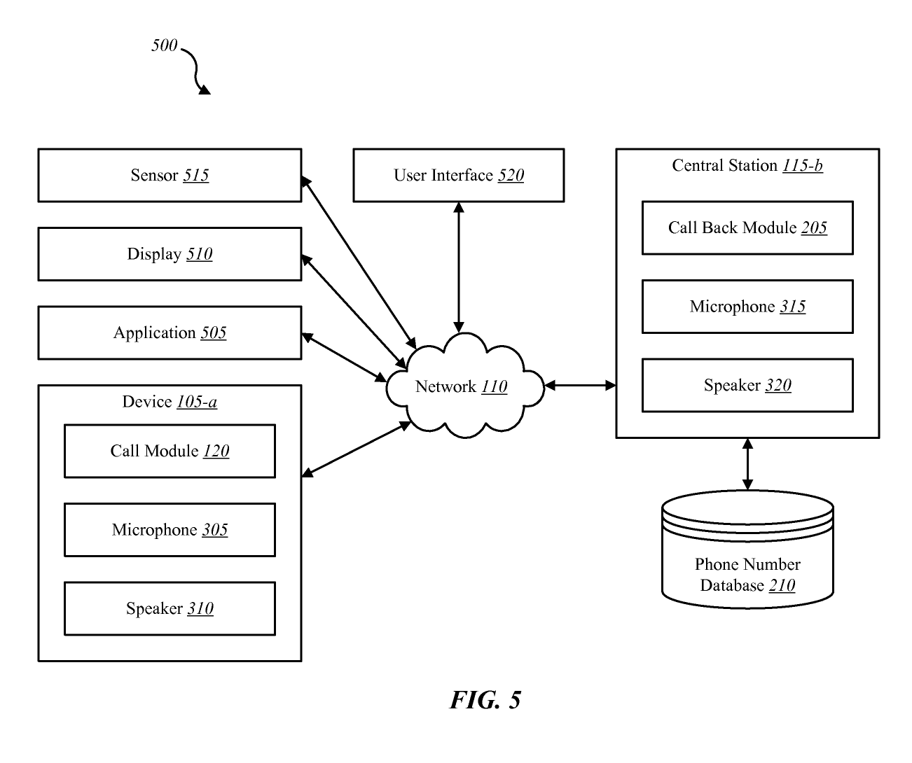

FIG. 5 shows another environment 500 that may include the components of environments 100, 200, 300, 400, described above, and may further include an application 505, a display 510, a sensor 515, and a user interface 520, in addition to device 105-a, central station 115-b and phone number database 210. The components shown in environment 500 may communicate directly with each other or via network 110. Application 505, display 510, sensor 515, and user interface 520 may be used with any of the environments 100, 200, 300, 400 described herein.

Application 505 may allow a user (e.g., a user interfacing directly with device 105-a located at a property being monitored by a home automation system) to control, either directly or via device 105-a, an aspect of the monitored property including security, energy management, locking and unlocking doors, checking the status of a door, locating a user or item, controlling lighting, thermostat, or cameras, and receiving notifications regarding a current status or anomaly associated with a home, office, place of business, and the like. In some configurations, application 505 may enable device 105-a to communicate with central station 115-b and/or phone number data base 210, and provide the user interface 520 to display an automation, security, and/or energy management content on device 105-a and/or central station 115-b. Thus, application 505, via user interface 520, may allow users to control aspects of their home, office, and/or other type of property. Further, application 505 may be installed on device 105-a, central station 115-b, phone number database 210, or other component and/or feature of a home automation system. Application 505 may facilitate identification of an alarm condition. Application 505 may operate to determine when an alarm condition has been resolved and/or updated to an inactive state.

Display 510 may include, for example, a digital display as part of, for example, a control panel of environment 500 (e.g., a control panel of the home automation system). Display 510 may be one example of the displays 405, 415 shown in FIG. 4. Display 510 may be provided via devices such as, for example, a desktop computer or a mobile computing device (e.g., a remote handheld device). In at least some examples, display 510 may be either permanently mounted (e.g., mounted to a wall of a home), or may be a mobile device or accessible via a mobile device. The user interface 520 may be integrated into display 510. Such a user interface 520 may include a plurality of menus, streams, microphones, speakers, cameras, and other capability that permit interaction between the user and the home automation system, or any component of environment 500. Additionally, or alternatively, the user interface 520, with display 510, may be integrated into device 105-a or any other features of a home automation system or environment 500.

Sensor 515 may include, for example, a camera sensor, an audio sensor, a forced entry sensor, a shock sensor, a proximity sensor, a boundary sensor, an appliance sensor, a light fixture sensor, a temperature sensor, a light beam sensor, a three-dimensional (3D) sensor, a motion sensor, a smoke sensor, a glass break sensor, a door sensor, a video sensor, a carbon monoxide sensor, an accelerometer, a global positioning system (GPS) sensor, a Wi-Fi positioning sensor, a capacitance sensor, a radio frequency sensor, a near-field sensor, a heartbeat sensor, a breathing sensor, an oxygen sensor, a carbon dioxide sensor, a brainwave sensor, a motion sensor, a voice sensor, a touch sensor, and the like. Device 105-a may have included or have integrated therein one or more of the sensors 515. Although sensor 515 is depicted as a separate component from device 105-a and central station 115-b, in some embodiments, sensor 515 may be connected directly to any one of those components or other components of environment 500. Additionally, or alternatively, sensor 515 may be integrated into a home appliance or fixture such as a lighting fixture. The information provided by sensor 515 may be used to generate or identify an alarm condition.

FIG. 6 is a block diagram illustrating an example call module 120-a. Call module 120-a may be one example of the call module 120 shown in any of FIGS. 1-5. Call module 120-a may include an alarm detection module 605, a call-out module 610, call receipt module 615, call-in mode module 620, connection confirmation module 625, and reconnect module 630.

Alarm detection module 605 may operate to determine if an alarm condition exists. The alarm condition may be detected using sensors (e.g., sensor 515 shown in FIG. 5) or other functionality of a home automation system. The alarm condition may be routed through a control panel of the home automation system (e.g., device 105 described with reference to FIGS. 1-5). Alarm detection module 605 may operate to track the state of the alarm condition. For example, once an alarm condition is identified, alarm detection module 605 may confirm that the alarm condition is active or in an active state. If the alarm condition is later changed to an inactive state, or is in some way resolved, alarm detection module 605 may generate a notice related to the change in status, which may influence other functionality of call module 120-a.

Call-out module 610 may operate to initiate a two-way call between, for example, device 105 and central station 115 described with reference to FIGS. 1-5. Call-out module 610 may use any number of different communication mediums and/or technologies to initiate the two-way call. For example, call-out module 610 may use a cellular network to create a two-way cellular phone call between device 105 and central station 115 (e.g., between call module 120 and call back module 205). Call module 120 may have a preprogrammed phone number for central station 115 such that call-out module 610 always calls the same phone number. In some examples, call module 120 may include a plurality of phone numbers for central station 115, and call-out module 610 randomly selects among the different phone numbers to create the two-way call, or uses the plurality of phone numbers in succession until one of the phone numbers is available to initiate the two-way call.

Call receipt module 615 may operate to receive incoming calls, such as calls from central station 115 via call back module 205. Call receipt module 615 may be activated based on, for example, identification of an alarm condition and confirmation that the alarm condition is active. Call receipt module 615 may be preprogrammed to receive calls from only certain phone numbers such as a preprogrammed phone number associated with central station 115. Restricting the sources for incoming calls may help reduce the likelihood of receiving unauthorized telephone calls at call module 120, such as calls not associated with an alarm condition and/or emergency.

Call-in mode module 620 may operate to activate and/or terminate a call-in mode for the home automation system. The call-in mode may be activated and/or terminated based on a state of an alarm condition.

Connection confirmation module 625 may operate to confirm the status of the two-way call between device 105 and central station 115. Connection confirmation module 625 may assess the quality of the two-way call such as, for example, the quality of cellular reception, bandwidth, etc., for the two-way call. In the event that the two-way call has poor quality, a connection confirmation module 625 may operate to intentionally terminate the two-way call. In the event that the two-way call is inadvertently terminated, connection confirmation module 625 may provide a notice that the two-way call is terminated and/or request reinitiation of the two-way call either by call module 120 or call back module 205 of central station 115.

Reconnect module 630 may operate to reinitiate the two-way call by call module 120. Reconnect module 630 may receive information from alarm detection module 605 to confirm that the alarm condition is in an active state prior to attempting to reinitiate the two-way call. Reconnect module 630 may also receive information from call receipt module 615 to confirm whether an incoming call has already been made in an attempt to reinitiate the two-way call via the call back module 205 of central station 115.

Call module 120-a may include more or fewer modules, functions and capabilities as compared to what is shown in call module 120-a of FIG. 6. In other embodiments, some of the functions of modules shown in FIG. 6 may be integrated into fewer modules or may be expanded into additional modules.

FIG. 7 is a block diagram illustrating an example call back module 205-a. Call back module 205-a may be one example of the call back module 205 shown in reference to FIGS. 2-5. Call back module 205-a may include a call connection module 705, a number look-up module 710, a panel call back module 715, an alarm status module 720, a call termination module 725, and a command module 730. Call connection module 705 may monitor the state of a two-way call between device 105 and central station 115 (e.g., between call module 120 and call back module 205). Call connection module 705 may monitor connection quality (e.g., a cellular reception quality) and may automatically terminate the call if there is insufficient connectivity or reception quality. Call connection module 705 may generate a notice if the two-way call is inadvertently or intentionally terminated.

Number look-up module 710 may operate to look up a phone number for device 105 as part of placing a call back call from central station 115 to device 105. Number look-up module 710 may reference a database of numbers such as phone number database 210. In another example, number look-up module 710 may reference a caller I.D. feature of a central station that provides the telephone number associated with the call received previously from device 105. Number look-up module 710 may display the number or plurality of possible numbers to an operator of central station 115 or to an automated call back feature of call back module 205-a.

Panel call back module 715 may operate to initiate a two-way call between central station 115 and device 105. Panel call back module 715 may use one or more numbers provided by number look-up module 710 to place the telephone call that initiates the two-way call. Panel call back module 715 may operate how to automatically give the previous two-way call that had been initiated by device 105-a is confirmed to have been inadvertently terminated and/or intentionally terminated based on poor connectivity or the like as determined by a call connection module 705. Panel call back module 715 may operate manually in response to input from an operator of central station 115.

Alarm status module 720 may monitor a state of an alarm condition that is used for the basis of an initial notice and/or two-way call-initiated by device 105. Alarm status module 720 may determine when a status of the alarm condition is changed from an active state to an inactive state. When the alarm condition is changed to an inactive state, alarm status module 720 may provide a notice that is used by call back module 205-a to cease attempting to place call back calls (e.g., via panel call back module 715). Alarm status module 720 may receive alarm status information from, for example, alarm detection module 605 of call module 120-a described with reference to FIG. 6.

Call termination module 725 may operate to terminate a two-way call between device 105 and central station 115 in response to, for example, a change in the alarm condition status or for connectivity, reception or bandwidth availability for the two-way call. Call termination module 725 may generate notices used by call back module 205-a in the event that the two-way call is intentionally terminated, whether the two-way call has been initiated by device 105 or by central station 115.

Command module 730 may generate a command that is transmitted to the home automation system (e.g., device 105 and/or call module 120) with instructions for the home automation system to re-initiate the two-way call. The command may be transmitted as an alternative to placing a call-back call to the home automation system. In one example, the command is transmitted, followed by a waiting period to confirm whether another call is received from the home automation system before a call back call is made. In other examples, a command is transmitted only if a call back call is unsuccessful to re-initiate the two-way call after a predetermined time period or certain number of attempts.

In other embodiments, call back module 205-a may include other modules in addition to those shown in FIG. 7. In other embodiments, at least some of the features and/or functionality of the modules described with reference to FIG. 7 may be combined into fewer or different modules. At least some of the modules of call module 120-a described with reference to FIG. 6 may be interchangeable with or cooperate with modules of call back module 205-a. In at least some examples, some or all of the modules and related functionality of call back module 205-a may be integrated into call module 120.

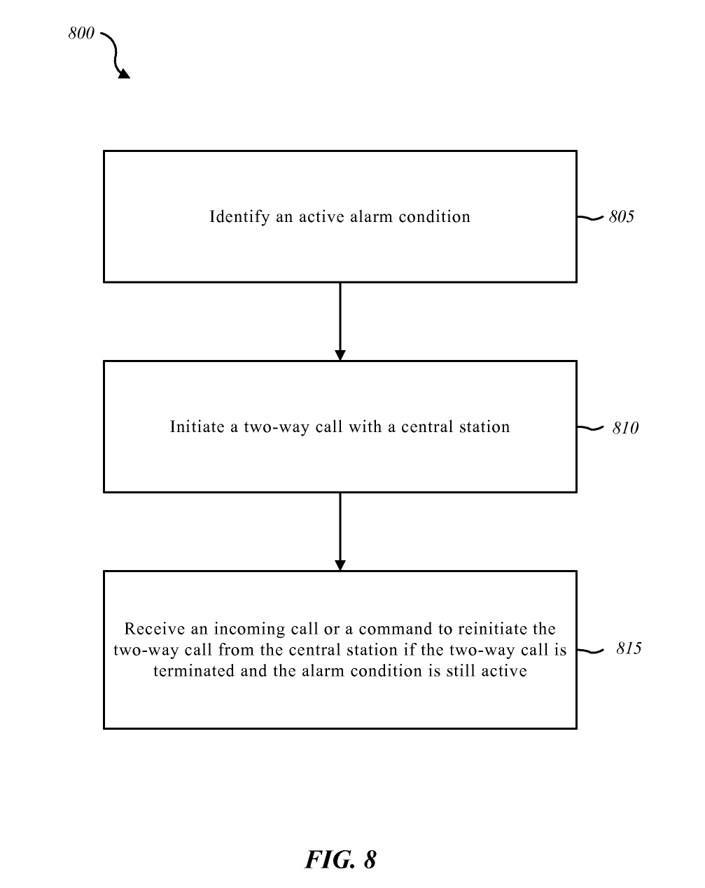

FIG. 8 is a flow diagram illustrating one embodiment of a method 800 for a two-way call back in a home automation system. In some configurations, the method 800 may be implemented with any of the call modules 120 and call back modules 205 described with reference to FIGS. 1, 2, 3, 4, 5, 6 and/or 7. In some examples, method 800 may be performed generally by device 105 or central station 115 shown in FIGS. 1-5, or even more generally by the environments 100, 200, 300, 400, 500 shown in FIGS. 1-5.

At block 805, method 800 includes identifying an active alarm condition. Block 810 of method 800 includes initiating a two-way call with a central station. Block 815 includes receiving an incoming call from the central station if the two-way call is terminated and the alarm condition is still active.

The method 800 may include initiating an incoming call mode prior to initiating the two-way call. The method 800 may include terminating the incoming call mode after the alarm condition becomes inactive. The method 800 may include changing the alarm condition to an inactive status upon resolution of the alarm condition. The method 800 may include preventing the incoming call from the central station after the alarm condition has the inactive status. The method 800 may include terminating the two-way call if a poor connection is detected. The two-way call may be a cellular phone call. The method 800 may include reinitiating the two-way call with the central station if the two-way call is terminated and the alarm condition is still active.

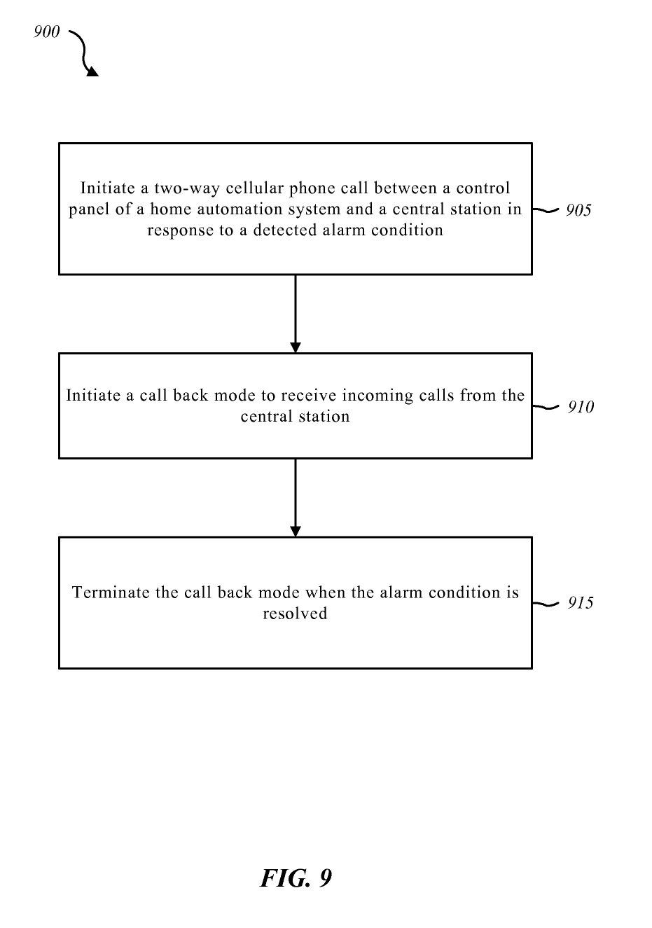

FIG. 9 is a flow diagram illustrating one embodiment of a method 900 for two-way call back. In some configurations, the method 900 may be implemented by any one of the call modules 120 and call back modules 205 described with reference to FIGS. 1-7. In other examples, method 900 may be performed generally by device 105 or central station 115 described with reference to FIGS. 1-5, or even more generally by the environments 100, 200, 300, 400, 500 shown in FIGS. 1-5.

At block 905, the method 900 includes initiating a two-way cellular phone call between a control panel of a home automation system and a central station in response to a detected alarm condition. Block 910 includes initiating a call back mode to receive incoming calls from the central station. Block 915 of method 900 includes terminating the call back mode when the alarm condition is resolved.

The method 900 may include receiving an incoming call from the central station if the two-way cellular call is terminated and the alarm condition is still active. The method 900 may include reinitiating the two-way cellular phone call if the two-way cellular call is terminated and the alarm condition is still active. The incoming call mode may be initiated before initiating a two-way cellular phone call. The method 900 may include detecting the alarm condition with the home automation system. The control panel may initiate and terminate the call back mode.

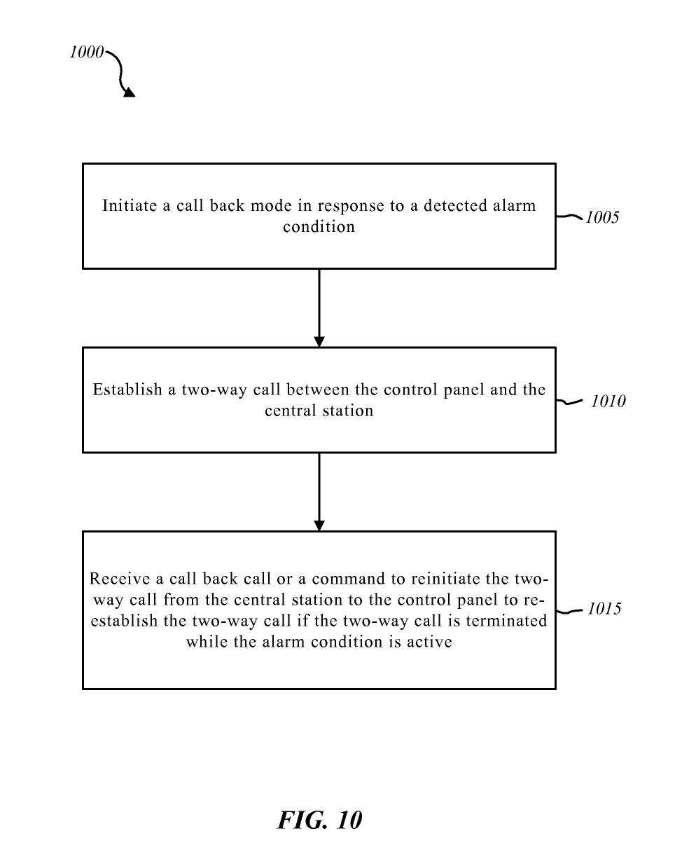

FIG. 10 is a flow diagram illustrating one embodiment of a method 1000 for a two-way call back between a control panel of a home automation system and a central station. The method 1000, in some configurations, may be implemented by any one of the call module 120 and call back module 205 described with reference to FIGS. 1-7. In other examples, method 1000 may be performed generally by any one of the devices 105 and central station 115 described with reference to FIGS. 1-5, or even more generally by the environments 100, 200, 300, 400, 500 shown in FIGS. 1-5.

At block 1005, the method 1000 includes initiating a call back mode in response to a detected alarm condition. Block 1010 includes establishing a two-way call between the control panel and the central station. Block 1015 of method 1000 includes receiving a call back call from the central station to the control panel to re-establish the two-way call if the two-way call is terminated while the alarm condition is active.

The method 1000 may further include terminating the call back mode after the alarm condition is resolved. Establishing a two-way call may include establishing a two-way cellular phone call. The control panel may initiate and/or terminate the call back mode. The call back mode may be initiated before establishing the two-way call. The method 1000 may include detecting the alarm condition with the home automation system

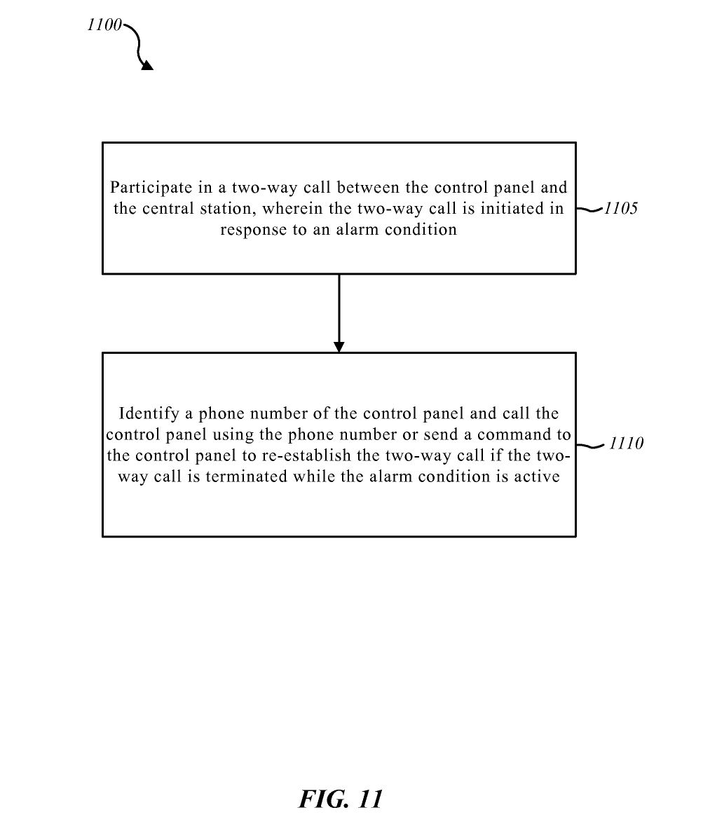

FIG. 11 is a flow diagram illustrating one embodiment of a method 1100 for two-way call back between a control panel of a home automation system and a central station. The method 1100, in some configurations, may be implemented by any one of the call module 120 and call back module 205 described with reference to FIGS. 1-7. In other examples, method 1100 may be performed generally by any one of the device 105 and central station 115 shown in FIGS. 1-5, or even more generally by the environments 100, 200, 300, 400, 500 shown in FIGS. 1-5.

At block 1105, the method 1100 includes participating in a two-way call between the control panel and the central station, wherein the two-way call is initiated in response to an alarm condition. Block 1110 provides that if a two-way call is terminated while the alarm condition is active, identifying a phone number of the control panel and calling the two-way panel using the phone number to reestablish the two-way call.

In one example, the two-way call is a cellular phone call and the method 1100 may include receiving a cellular phone call from the control panel. Identifying the phone number includes searching a database of phone numbers. The database of phone numbers may include the phone numbers for a plurality of control panels associated with a plurality of different home automation systems. Identifying the phone number may include using an caller I.D. function. The method 1100 may include confirming that the alarm condition is active prior to calling the control panel.

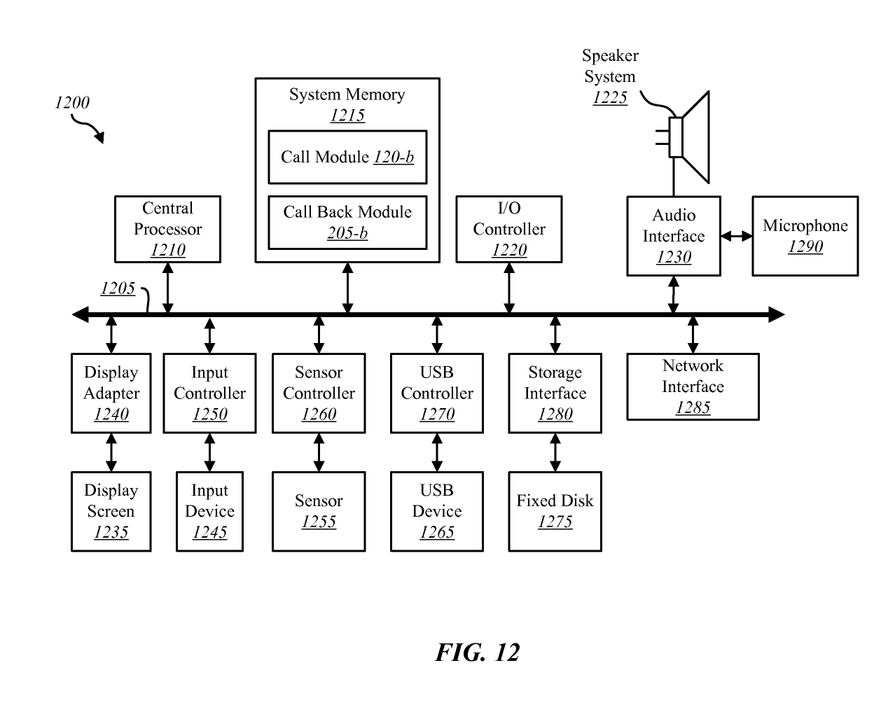

FIG. 12 depicts a block diagram of a controller 1200 suitable for implementing the present systems and methods. The controller 1200 may be an example of the device 105 and/or central station 115 illustrated in FIGS. 1, 2, 3, 4 and/or 5. In one configuration, controller 1200 includes a bus 1205 which interconnects major subsystems of controller 1200, such as a central processor 1210, a system memory 1215 (typically RAM, but which may also include ROM, flash RAM, or the like), an input/output controller 1220, an external audio device, such as a speaker system 1225 and microphone 1290 via an audio output interface 1230, an external device, such as a display screen 1235 via display adapter 1240, an input device 1245 (e.g., remote control device interfaced with an input controller 1250), multiple USB devices 1265 (interfaced with a USB controller 1270), and a storage interface 1280. Also included are at least one sensor 1255 connected to bus 1205 through a sensor controller 1260 and a network interface 1285 (coupled directly to bus 1205).

Bus 1205 allows data communication between central processor 1210 and system memory 1215, which may include read-only memory (ROM) or flash memory (neither shown), and random access memory (RAM) (not shown), as previously noted. Call module 120-b, which may be one example of call module 120 shown in FIGS. 1-6, and call back module 205-b, which may be one example of call back module 205 shown in FIGS. 2-5 and 7, may be stored in system memory 1215. Any of the modules discloses with reference to FIGS. 1-7 may be stored in system memory 1215. The RAM is generally the main memory into which the operating system and application programs are loaded. The ROM or flash memory can contain, among other code, the Basic Input-Output system (BIOS) which controls basic hardware operation such as the interaction with peripheral components or devices. Applications (e.g., application 505) resident with controller 1200 are generally stored on and accessed via a non-transitory computer readable medium, such as a hard disk drive (e.g., fixed disk 1275) or other storage medium. Additionally, applications can be in the form of electronic signals modulated in accordance with the application and data communication technology when accessed via interface 1285.

Storage interface 1280, as with the other storage interfaces of controller 1200, can connect to a standard computer readable medium for storage and/or retrieval of information, such as a fixed disk drive 1275. Fixed disk drive 1275 may be a part of controller 1200 or may be separate and accessed through other interface systems. Network interface 1285 may provide a direct connection to a remote server via a direct network link to the Internet via a POP (point of presence). Network interface 1285 may provide such connection using wireless techniques, including digital cellular telephone connection, Cellular Digital Packet Data (CDPD) connection, digital satellite data connection, or the like. In some embodiments, one or more sensors (e.g., motion sensor, smoke sensor, glass break sensor, door sensor, window sensor, carbon monoxide sensor, and the like) connect to controller 1200 wirelessly via network interface 1285.

Many other devices or subsystems (not shown) may be connected in a similar manner (e.g., entertainment system, computing device, remote cameras, wireless key fob, wall mounted user interface device, cell radio module, battery, alarm siren, door lock, lighting system, thermostat, home appliance monitor, utility equipment monitor, and so on). Conversely, all of the devices shown in FIG. 12 need not be present to practice the present systems and methods. The devices and subsystems can be interconnected in different ways from that shown in FIG. 12. The aspect of some operations of a system such as that shown in FIG. 12 are readily known in the art and are not discussed in detail in this application. Code to implement the present disclosure can be stored in a non-transitory computer-readable medium such as one or more of system memory 1215 or fixed disk 1275. The operating system provided on controller 1200 may be iOS®, ANDROID®, MS-dOS®, MS-WINDOWS®, OS/2®, UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. An apparatus for two-way call back in a home automation system, comprising:
a processor;
a memory in electronic communication with the processor; and
instructions stored in the memory, the instructions being executable by the processor to:
identify an active alarm condition;
initiate a two-way call with a central station; and
receive an incoming call or a command to reinitiate the two-way call from the central station if the two-way call is terminated and the alarm condition is still active.

2. The apparatus of claim 1, wherein the instructions are executable by the processor to:
initiate an incoming call mode prior to initiating the two-way call.

3. The apparatus of claim 2, wherein the instructions are executable by the processor to:
terminate the incoming call mode after the alarm condition becomes inactive.

4. The apparatus of claim 1, wherein the instructions are executable by the processor to:
change the alarm condition to an inactive status upon resolution of the alarm condition.

5. The apparatus of claim 4, wherein the instructions are executable by the processor to:
prevent the incoming call from the central station after the alarm condition has the inactive status.

6. The apparatus of claim 1, wherein the instructions are executable by the processor to:
terminate the two-way call if a poor connection is detected.

7. The apparatus of claim 1, wherein the two-way call is a cellular phone call.

8. The apparatus of claim 1, wherein the instructions are executable by the processor to:
re-initiate the two-way call with the central station if the two-way call is terminated and the alarm condition is still active.

9. A computer-implemented method for two-way call back between a control panel of a home automation system and a central station, comprising:
initiating a call back mode in response to a detected alarm condition;
establishing a two-way call between the control panel and the central station; and
receiving a call back call or a command to reinitiate the two-way call from the central station to the control panel to re-establish the two-way call if the two-way call is terminated while the alarm condition is active.

10. The method of claim 9, further comprising:
terminating the call back mode after the alarm condition is resolved.

11. The method of claim 9, wherein establishing the two-way call includes establishing a two-way cellular phone call.

12. The method of claim 9, wherein the control panel initiates and terminates the call back mode.

13. The method of claim 9, wherein the call back mode is initiated before establishing the two-way call.

14. The method of claim 9, further comprising:
detecting the alarm condition with the home automation system.

15. A computer-implemented method for two-way call back between a control panel of a home automation system and a central station, comprising:
participating in a two-way call between the control panel and the central station, the two-way call being initiated in response to an alarm condition; and
if the two-way call is terminated while the alarm condition is active:
identifying a phone number of the control panel; and
calling the control panel using the phone number or sending a command to the control panel to re-establish the two-way call.

16. The method of claim 15, wherein the two-way call is a cellular phone call, and the method comprises receiving the cellular phone call from the control panel.

17. The method of claim 15, wherein identifying the phone number includes searching a database of phone numbers.

18. The method of claim 17, wherein the database of phone numbers includes phone numbers for a plurality of control panels associated with a plurality of different home automation systems.

19. The method of claim 15, wherein identifying the phone number includes using a caller ID function.

20. The method of claim 15, further comprising:
confirming that the alarm condition is active prior to calling the control panel.
